(19) United States
(12) Patent Application Publication
(10) Pub. No.: US 2024/0097548 A1
(43) Pub. Date: Mar. 21, 2024

(54) PROTECTION FOR THE COILS OF AN ELECTRIC MACHINE

(71) Applicants: SAFRAN, PARIS (FR); UNIVERSITE DE LORRAINE, NANCY (FR)

(72) Inventors: Sabrina Siham AYAT, MOISSY-CRAMAYEL (FR); Rémi Luc Stéphane DORGET, MOISSY-CRAMAYEL (FR); Benjamin DAGUSE, MOISSY-CRAMAYEL (FR)

(73) Assignees: SAFRAN, PARIS (FR); UNIVERSITE DE LORRAINE, NANCY (FR)

(21) Appl. No.: 18/273,428

(22) PCT Filed: Jan. 18, 2022
(86) PCT No.: PCT/FR2022/050099

§ 371 Date: Jul. 20, 2023

(30) Foreign Application Priority Data
Jan. 21, 2021 (FR) FR2100429

(51) Int. Cl. H02K 55/00; B64D 27/24; H01F 6/00

(52) U.S. Cl. CPC H02K 55/00; B64D 27/24; H01F 6/00

(57) ABSTRACT

This invention relates to a superconducting electric machine (1), for example with axial flux or with radial flux, comprising an inductor (3) comprising superconducting pellets (7) circumferentially distributed around an axis (X) of the electric machine (1) and a flux barrier (12) comprising a superconducting material, said flux barrier (12) being centered on the axis (X) of rotation and extending radially inward of the superconducting pellets (7).

### TECHNICAL FIELD

This disclosure relates to the field of electric machines comprising superconducting pellets that can in particular be used in aircraft. In particular, the disclosure is applicable to electric machines comprising magnetic or non-magnetic pellets, to electric machines with superconducting magnets or with superconducting flux barriers, entirely superconducting machines (superconducting armature and inductor) or partially superconducting (superconducting armature or inductor) as well as to radial or axial flux superconducting machines.

### BACKGROUND

A field of engineering is concerned with future means of transport, seeking to make systems more environmentally friendly. In the field of air transport, various projects and prototypes are already in existence, such as SOLAR IMPULSE or the Airbus E-FAN. Environmental concerns and the reduction in fuel consumption and noise are all criteria that encourage the use of electric machines. To be able to replace the current technologies, aeronautical manufacturers are working increasing the power density of these electric machines. A study is thus being carried out on the gain that HCT superconducting materials would provide for on-board actuators.

A superconducting material is a material which, when cooled at a temperature below its critical temperature, has zero resistivity, thus offering the possibility for DC currents to flow without losses. This results in several phenomena, such as the diamagnetic response for any variation in the magnetic field, which can be used to make excellent magnetic shields.

In a manner known per se, an electric machine comprises an inductor and an armature. The inductor comprises an HCT coil made with HCT wires which generates a magnetic field modulated by superconducting pellets, which serve as magnetic screens. The armature, meanwhile, comprises a three-phase copper winding system comprising an arrangement of coils which rest on a ferromagnetic or non-magnetic support. The rotation of the screens causes the magnetic field to vary and induces an electromotive force in the coils by Lenz' law. The dimensioning of such a machine leads to an axial flux structure with no rotary supply system (slip ring/brush type). The maintenance and the safety problems caused by a rotary slip ring/brush system are therefore avoided.

This electric machine is partially superconducting insofar as only the inductor is made of a superconducting material, as opposed to a totally superconducting machine, all the active parts of which are designed with superconducting materials.

In the remainder of the text, the term “inductor” will refer to the HCT coil and the superconducting pellets configured to modulate the magnetic flux created by the HCT coil. Note that, in a superconducting electric machine with flux barriers, use is made of the diamagnetic behavior of the superconducting pellets when they are cooled outside the field. The superconducting pellets are in this case non-magnetic and form a screen (screening) which deflects the field lines, when they are placed under a magnetic field. The magnetic field is then concentrated and of high amplitude between the non-magnetic superconducting pellets and of low amplitude downstream of these pellets. In a variant, the superconducting pellets can be magnetic and form superconducting magnets. This is referred to as a superconducting magnet machine.

Generally, the pellets are made of at least one of the following materials which in particular possess very good screening features: made of YBCO (Yttrium Barium Copper Oxide), GdBCO (Gadolinium-Barium-Copper-Oxygen), NbTi (niobium-titanium), in MgB2 (magnesium diboride) or any RE-Ba—Cu—O material where RE can be any rare earth.

The pellets are generally obtained using the method of growing from seeds. The reader is referred to the article by M. Morita, H. Teshima, and H. Hirano, “Development of oxide superconductors”, Nippon Steel Technical Report, vol. 93, p. 18-23, 2006 for more details on this method. In particular, this type of method consists in forming a crystal by gradual solidification of material on the surface of a pre-existing seed. The pellets thus obtained are therefore generally of circular or rectangular shape. In a variant, provision has also been made for making the pellets by sintering. However, the inter-grain connection associated with this manufacturing method tends to reduce the performance of the pellets. Another method consists in using superconducting tapes for the manufacturing of superconducting pellets. This is referred to as a stack of tapes. These pellets, the superconducting core of which is reinforced by the matrix of the tapes forming them, have good mechanical strength. This good mechanical strength is particularly advantageous when the pellets are magnetic (superconducting magnet machine).

However, the Applicant has observed that the concentration of the magnetic flux on the coils of the armature was not optimal, which not only reduces the power density of the electric machines but also risks saturating the ferromagnetic material parts and causing faults in the electric machine.

### SUMMARY

An aim of the disclosure is to increase, simply and effectively, the power density of superconducting machines.

Another aim of the disclosure is to reduce the risks of causing faults in superconducting machines.

The disclosure applies to any type of superconducting machine, which particularly comprise partially superconducting or totally superconducting machines, machines with flux barriers or with superconducting magnets, with axial or radial flux.

For this purpose provision is made, according to a first aspect of the disclosure, for a superconducting electric machine, for example with axial flux or with radial flux, comprising an inductor comprising superconducting pellets circumferentially distributed around an axis of the electric machine. The electric machine further comprises a flux barrier comprising a superconducting material, said flux barrier being centered on the axis of rotation and extending radially inward of the superconducting pellets.

Certain preferred but non-limiting features of the electric machine according to the first aspect are as follows, taken individually or in combination:
the flux barrier comprises an annular strip extending in a plane radial to the axis, said annular strip being coaxial with the axis;
the flux barrier comprises an annular strip extending circumferentially around the axis;
the electric machine further comprises at least one face extending radially toward the axis from the annular strip, preferably two opposite faces axially offset with respect to one another;
the electric machine further comprises a drive shaft configured to rotationally drive the superconducting pellets around the axis, the face of the flux barrier comprising a through orifice and the drive shaft passing through the through orifice such that the flux barrier is mounted around the drive shaft;
the electric machine further comprises an assembly for cooling the superconducting pellets and/or the ferrofluid seals mounted in proximity to the drive shaft through the through orifice; such that the flux barrier is mounted around the cooling assembly and/or the ferrofluid seals;
the electric machine further comprises an armature comprising coils circumferentially distributed around the axis, the flux barrier moving as a single part with the armature;
the flux barrier moves as a single part with the superconducting pellets;
the flux barrier is continuous over its entire periphery;
the electric machine is of axial flux type, the flux barrier extending between the superconducting pellets and the armature such as to at least partially cover the radially inner edge of all or part of the coils of the armature; and/or
each coil furthermore has lateral edges extending radially from the radially inner edge, the flux barrier covering at the most 10% of the lateral edges.

According to a second aspect, the disclosure makes provision for an aircraft comprising an electric machine according to the first aspect.

### DESCRIPTION OF THE DRAWINGS

Other features, aims and advantages of the disclosure will become apparent from the following description, which is purely illustrative and non-limiting, and which must be read with reference to the appended drawings wherein:

FIG. 1 is a simplified section view of an axial flux electric machine according to a first embodiment, wherein the flux barrier is attached to the superconducting pellets;

FIG. 2 is a simplified, exploded and perspective view of an axial flux electric machine according to a second embodiment, wherein the flux barrier is attached to the coils of the armature;

FIG. 3 is a simplified, exploded and perspective view of a radial flux electric machine according to a third embodiment of the invention, wherein the flux barrier is attached to the support structure of the superconducting pellets, the adiabatic chamber having been omitted;

FIG. 4 is a simplified, exploded and perspective view of a variant embodiment of the radial flux electric machine of FIG. 4, the adiabatic chamber having been omitted;

FIG. 5 is a partial perspective view of an exemplary embodiment of a flux barrier; and

FIG. 6 is a schematic view of an aircraft comprising an electric machine.

In all the figures, similar elements bear identical reference numbers.

### DETAILED DESCRIPTION

In the remainder of the text, the invention will be described and illustrated for the case of a partially superconducting axial flux electric machine 1 with flux barriers with non-magnetic pellets. As has already been stated above, this is however non-limiting, the invention also applying mutatis mutandis to electric machines comprising magnetic pellets, to electric machines with superconducting magnets, to entirely superconducting electric machines (superconducting armature and inductor) as well as to radial flux electric machines.

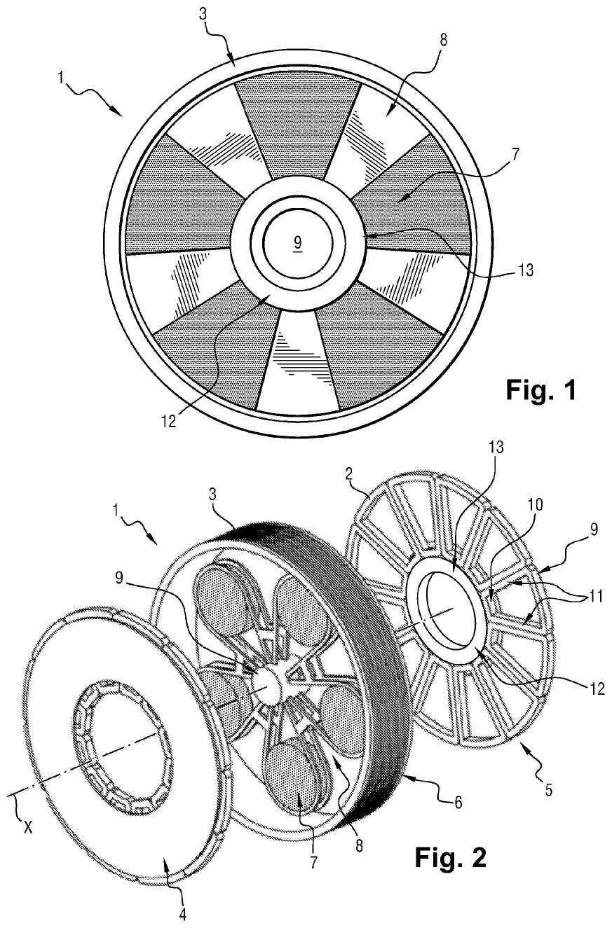

FIG. 1 schematically represents a superconducting axial flux electric machine 1 with flux barriers according to an embodiment conventionally comprising a rotating part, or rotor, and a fixed part, or stator.

In this application, the axis of rotation of the rotor is referred to as its axis X. The axial direction corresponds to the axis X and a radial direction is a direction perpendicular to this axis and passing through it. Moreover, the circumferential (or lateral) direction corresponds to a direction perpendicular to the axis X and not passing through it. Unless otherwise specified, the terms “inner” (or “inward” respectively) and “outer” (or “outward” respectively), are used with reference to a radial direction such that the inner part or face of an element is closer to the axis X than the outer part or face of the same element.

In a manner known per se, the superconducting axial flux electric machine 1 comprises an armature 2 and an inductor 3. The armature 2 includes an arrangement 4 of non-superconducting electromagnetic coils 5, generally made of copper. The inductor 3 includes a superconducting coil 6 coaxial with the arrangement 4 of the electromagnetic coils 5 of the armature 2 and the superconducting pellets 7 mounted on a bearing structure 8 which are disposed in one and the same plane orthogonal to the axis X and radially inward of the superconducting coil 6. Optionally, the inductor 3 further comprises a stator yoke including an iron ring 8. Here the rotor is formed by superconducting pellets 7 which are rotationally driven about an axis of rotation extending along the axial direction. The stator is formed by the arrangement 4 of electromagnetic coils 5 and the superconducting coil 6.

The superconducting pellets 7 are made of superconducting material and are distributed equidistantly around the axis of rotation, which allows a spatial variation in the electromagnetic field in the air gap. Here, the superconducting pellets 7 are non-magnetic. In a variant, the superconducting pellets 7 could be magnetic. For example, the pellets are made of YBCO (Yttrium Barium Copper Oxide), GdBCO (Gadolinium-Barium-Copper-Oxygen), NbTi (niobium-titanium), MgB2 (magnesium diboride) or any other RE-Ba—Cu—O material where RE can be any rare earth.

The superconducting coil 6 of the inductor 3 is a static superconducting coil supplied with a DC current. Where applicable, when the electric machine 1 comprises a yoke 4, this provides a good mechanical strength of the electromagnetic coils 5 of the armature 2. In other words, the inductor 3 is superconducting while the armature 2 is non-superconducting.

The superconducting pellets 7 can have any suitable form.

In a first embodiment, each superconducting pellet 7 has, in a manner known per se, the form of a solid disc (as illustrated in FIG. 2).

In a second embodiment, the superconducting pellet 7 can be hollow in order to adapt its shape to the thickness of penetration of the magnetic field in the pellet 7 (as illustrated in FIG. 1). Each superconducting pellet 7 comprises for this purpose a circumferential wall which has:
a first edge,
a second edge opposite the first edge
an inner face connecting the first edge and the second edge
an outer face opposite the inner face and
a cavity formed between the first edge, the second edge and delimited by the inner face of the circumferential wall.

The inner face extends radially inward of the outer face. The superconducting pellet 7 is therefore hollow in that it has a cavity which, as will be seen below, can be open, through or enclosed in the superconducting pellet 7. The cavity is preferably empty (devoid of material).

Optionally, the superconducting pellet 7 may comprise one or more additional walls dividing the cavity into several parts. Where applicable, a through orifice can be formed out of all or part of the walls. The reader is referred to the document FR3104804 in the name of the Applicant for more details on these different forms of production of superconducting pellets 7 with a cavity.

In a third embodiment illustrated in FIGS. 2, 4a and 5a, the shape of the superconducting pellets 7 is adapted (optimized) such as to maximize the screening/weight ratio of the pellets 7, i.e. the shape of the superconducting pellets 7 is adapted so that the variation in the axial component of the induced magnetic field, and therefore the screening of the magnetic flux, is maximal, while minimizing the weight of the superconducting pellets 7. One can thus obtain an increase in the speed of rotation of the rotor and therefore of the power of the electric machine. For this purpose the superconducting pellets 7 can have a polygonal shape having at least five sides. For example, the pellet 7 has a hexagonal shape, preferably that of an isometric regular hexagon. In a variant, the face 8 of each superconducting pellet 7 has the geometry and the dimensions of a ring sector. The term “ring sector” will here be understood to mean the shape delimited on the one hand by two coaxial circles, of different diameter, and on the other hand by two straight line segments coming from the center of the circles. The ring sector thus comprises two curved opposite sides and two straight opposite sides.

The reader is referred to the document FR3104803 the name of the Applicant for more details about these different forms of embodiment of superconducting pellets 7.

The magnetic field is generated by the superconducting coil 6. Consequently, it is enough to switch off the superconducting coil 6 to cut off the magnetic field in the superconducting electric machine. This offers an advantage insofar as superconducting pellets 7 which are cooled in the presence of a magnetic field are not capable of screening the magnetic field. Thus, it is necessary for the magnetic field to be screened to appear at a time after the cooling of the superconducting pellets 7 to allow them to play their role of magnetic screens, which is made possible by the use of the superconducting coil 6. The superconducting coil 6 can therefore be switched off when the superconducting pellets 7 are hot and switched on once they are cooled.

The coils 5 of the armature 2 can also have any suitable shape. In a manner known per se, the coils 5 can in particular have a ring sector shape.

Whatever the shape of the coils 5 of the armature 2, each coil has a radially inner edge 10, a radially outer edge 9 and lateral edges 11 which connect the radially inner edge 10 and the radially outer edge 9. The radially inner edge 10 and the radially outer edge 9 extend along a circumferential direction with respect to the axis X while the lateral edges 11 are substantially radial.

In a manner known per se, the electric machine 1 further comprises a drive shaft, coaxial with the axis X, configured to rotationally drive the rotor, i.e. here the bearing structure on which the superconducting pellets 7 are mounted, as well as an assembly for cooling the superconducting pellets 7 and the seals, for example magnetic seals comprising ferrofluids. The part of the shaft passing through the armature 2 and the inductor 3, the cooling assembly and the seals are generally housed in an adiabatic chamber 9. In the figures, only the adiabatic chamber 9 can be seen (FIG. 2). The adiabatic chamber 9 extends radially inward with respect to the superconducting pellets 7.

The cooling assembly generally includes a cryostat comprising a rotating part and a fixed part housed in a chamber. The seals are configured to provide a seal between the rotating part and the fixed part of the cryostat.

To improve, simply and effectively, the power density of the superconducting electric machine 1, the electric machine 1 further comprises a flux barrier 12 comprising a superconducting material, which is centered on the axis X of rotation and which extends radially inward of the superconducting pellets 7 and radially outward of the adiabatic chamber 9. The flux barrier 12 is therefore positioned at the center of the electric machine 1 such as to mask the parts which do not participate in the generation of the torque, such as the drive shaft, the cooling assembly or the seals. The flux barrier 12 thus forms a screen for the parts housed in the adiabatic chamber 9, which do not participate in the generation of torque, which makes it possible to concentrate the magnetic flux at the superconducting pellets 7, and therefore to increase the power density of the electric machine 1.

In a form of embodiment, the flux barrier 12 is placed between the superconducting pellets 7 and the axis X, around the parts housed in the adiabatic chamber 9, and extends continuously along the entire inner periphery of the superconducting pellets 7. The flux barrier 12 is furthermore coaxial with the axis X. The magnetic flux is thus screened over 360° and the power density of the electric machine 1 is maximized. Assuming that the magnetic field created by the superconducting coil 6 alone varies very little over its radius, half of the magnetic flux of this same coil 6 passes through the parts housed in the adiabatic chamber 9. Hence, the presence of the flux barrier 12 makes it possible to recover 50% of the magnetic flux to increase the induction in the working part, and therefore to increase the power density of the electric machine 1 by approximately 30%.

In addition, the parts of the electric machine 1 which comprise ferromagnetic materials, such as the seals if they include ferromagnetic parts, are then protected from the magnetic field. Specifically, in the absence of any flux barrier 12, there is a risk of saturating these ferromagnetic materials and therefore of causing a fault in the cooling assembly, and therefore the electric machine 1.

The flux barrier 12 can be made of any of the superconducting materials envisioned for the superconducting pellets 7 listed above. Where applicable, the flux barrier 12 can be made of the same superconducting material as the pellets 7. The flux barrier 12 can moreover be cooled in a similar way to the superconducting pellets 7.

The flux barrier 12 can be attached to the rotor or the stator in the electric machine 1.

In a first form of embodiment illustrated in FIG. 1, the flux barrier 12 is attached to the rotor of the electric machine 1, for example to the superconducting pellets 7 and/or to the bearing structure 8 on which the superconducting pellets 7 are mounted. This configuration makes it possible to use a flux barrier 12 having a greater thickness (in the order of ten to twenty millimeters in thickness) and therefore to further improve the screening of the magnetic field. Specifically, when the flux barrier 12 is attached at the rotor, it can form a single unit with the superconducting pellets 7 used for the modulation of the flux. These pellets 7 are typically thicker than the flux barrier used for protection (a good quality of screening being required for the modulation of the field). However, when the flux barrier 12 and the pellets 7 are a single unit, for the sake of simplicity of production, they can have the same thickness. One consequence of this is the improvement of the screening for the ‘protective’ flux barrier 12.

The flux barrier 12 can for example be attached to a radially inner edge of the superconducting pellets 7 (i.e. the edge of the superconducting pellets 7 that is closest to the axis X).

In a variant, as illustrated in FIG. 2, the flux barrier 12 can be mounted on the stator of the electric machine, for example on the coils 5 of the armature 2. In this case, the thickness of the flux barrier 12 can be less than one millimeter to avoid impeding the operation of the electric machine 1. Specifically, when the flux barrier 12 is mounted on the coils 5 of the armature 2, it is then located at the air gap of the electric machine 1. However, this air gap must also be as small as possible since it is directly proportional to the torque of the electric machine 1 (and therefore to its power). That is why, in this configuration, it is preferable to limit the thickness of the flux barrier 12.

Preferably, an outer radius of the flux barrier 12 is less than or equal to an inner radius of the superconducting pellets 7 in order to avoid disrupting the screening of the magnetic field by the superconducting pellets 7. The term “outer radius of the flux barrier 12” should here be understood to mean the maximum radius of the flux barrier 12, measured from the axis X of rotation. The term “inner radius of the superconducting pellets” 7 should here be understood to mean the minimum radius of said pellets 7, measured from the axis X of rotation.

Thus, when the flux barrier 12 is attached to the superconducting pellets 7 and/or to their bearing structure, said flux barrier 12 does not extend radially beyond the superconducting pellets 7.

A radial length (i.e. along an axis radial to the axis X) of the flux barrier is less than the air gap between the adiabatic chamber 9 and the inner radius of the superconducting pellets 7.

The flux barrier 12 extends substantially continuously around the axis X to ensure the development of current loops in the flux barrier 12 which channel the magnetic flux and thus improve the redirection of the flux toward the active parts of the electric machine 1. Thus, the flux barrier 12 does not comprise several sections bonded to one another along the circumferential direction, but comprises a single continuous part over its circumference.

In a form of embodiment, (illustrated for example in FIG. 2), the height of the flux barrier 12 is such that said barrier 12 extends in front of a radially inner edge 10 of all or part of the coils 5 of the armature, preferably of all the coils 5, such as to at least partially cover their edge 10. Preferably, the flux barrier covers the entire radially inner edge 10 of the coils 5, covering between 0% and 10% of the lateral edges 11. For a maximum power density, the flux barrier 12 does not cover the lateral sides 11.

This configuration then makes it possible to reduce the risks of deformation of the coils 5 of the armature 2 while improving the power density of the electric machine 1. Specifically, the forces at the radially inner edge 10 of the coils 5 do not produce any torque but are liable to deform the coils 5. Owing to the flux barrier 12, the magnetic field is then screened at the radially inner edge 10 of the coils 5 and redirected from the armature 2 toward the active regions of the electric machine 1, i.e. radially in the direction of the lateral edges 11 and of the radially outer edge 9 of the coils 5, which makes it possible to increase the power density of the electric machine 1.

The flux barrier 12 can be of overall angular shape and centered on the axis X.

In a first form of embodiment (as illustrated in FIGS. 1 and 2, the flux barrier 12 can have the shape of a disk in which a through orifice is made such as to obtain an annular strip 13 extending in a plane radial to the axis X. The adiabatic chamber 9 (which houses the drive shaft, the cooling assembly and the ferrofluid seals) is thus placed with respect to the flux barrier 12 such as to extend through the through orifice of the annular strip 13. The flux barrier 12 is therefore mounted around these parts of the electric machine.

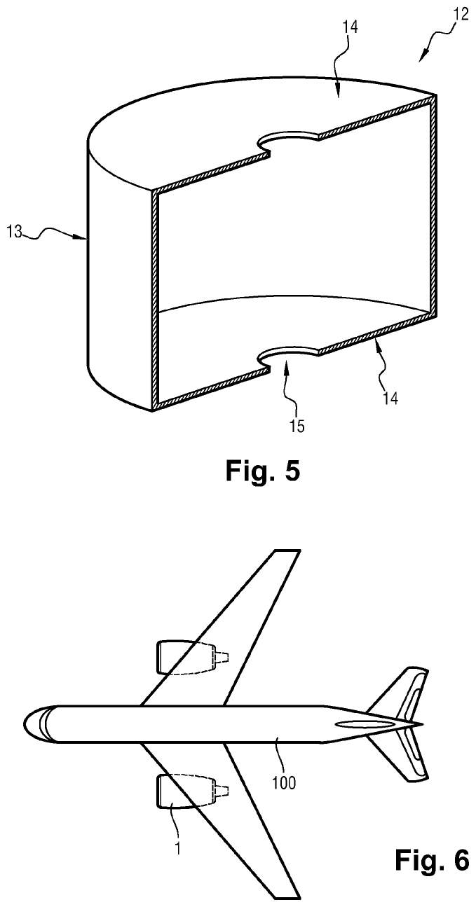

In a second form of embodiment illustrated in FIG. 5, the flux barrier 12 comprises an annular strip 13 extending circumferentially around the axis X such as to form a revolution cylinder centered on the axis X. Here again, the drive shaft, the cooling assembly and the ferrofluid seals are thus placed with respect to the flux barrier 12 such as to extend through the inner space delimited by the annular strip 13. Optionally, the flux barrier 12 further comprises at least one face 14 extending radially toward the axis X from the annular edge, preferably two opposite faces 14 axially offset from one another. Each face 14 then comprises a through orifice 15 allowing the passage in particular of the drive shaft, such that the drive shaft, the cooling assembly and the seals are at least partially housed inside the annular strip 13 of the flux barrier 12.

Whatever the configuration (radial or circumferential) of the annular strip 13, said annular strip 13 is preferably substantially continuous along the circumferential direction. In the case where the annular strip 13 is formed entirely as a single part with the superconducting pellets 7, the thickness of the annular strip 13 can be substantially equal to that of the pellets 7 to simplify the manufacturing of this part of the rotor.

### Manufacturing Method

The flux barrier 12 can be obtained by growing from seeds or by stacking of tapes.

When the flux barrier 12, 12′ is obtained by growing from seeds, the manufacturing method comprises the following steps:
producing a conventional pellet-type part, in the shape of a disc or rectangle by growing from seeds;
machining the part thus obtained such as to obtain the final shape of the flux barrier 12 12.

In the case of a flux barrier 12 of annular strip 13 type (radial or circumferential), the part obtained by growing from a seed preferably has the shape of a disc and the machining step consists in producing a through central orifice 15 in the disc such as to obtain the annular strip 13.

When the flux barrier 12 is obtained by stacking of tapes, the manufacturing method comprises the following steps:
precutting the tapes such as to obtain the annular strip of the flux barrier 12;
conventionally stacking the tapes thus precut to obtain the flux barrier 12; and
optionally, machining the superconducting pellet 7 thus obtained.

Where applicable, when the flux barrier 12 is attached to the superconducting pellets 7, the flux barrier 12 and the superconducting pellets 7 can be entirely formed as a single part. In other words, the flux barrier 12 and the superconducting pellets 7 can be manufactured simultaneously by growing from seeds or by stacking of tapes. To do this, the superconducting pellets 7 and the flux barrier 12 can be obtained by producing a pellet 7 in the shape of a disc, the outer radius of which is equal to that of the superconducting pellets 7, then by machining this pellet 7 in order to form the central orifice 15 of the flux barrier 12 along with the spaces between the pellets 7. The thickness of the flux barrier 12 is then equal to the thickness of the superconducting pellets 7 (generally, in the order of ten to twenty millimeters).

Note that, when the flux barrier 12 is attached to the stator, the flux barrier 12 is preferably made by stacking of tapes in order to be able to obtain thicknesses of less than one millimeter.

### Application to Radial Flux Electric Machines

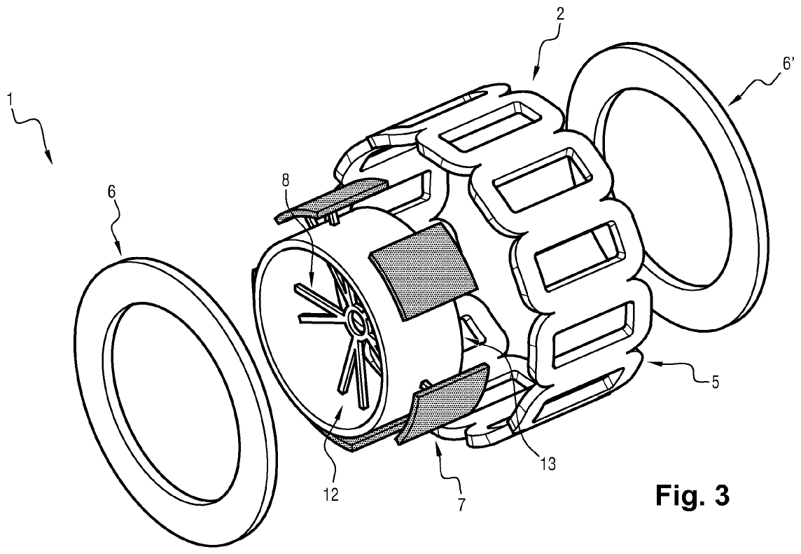

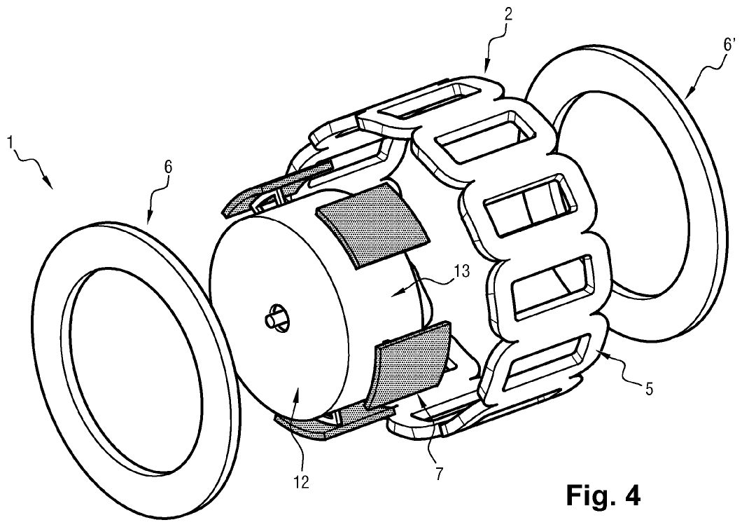

In the case of a radial flux electric machine (see for example FIGS. 3 and 4), the inductor 3 includes a front superconducting coil 6 and a rear superconducting coil 6′ which are annular and coaxial with the axis X of rotation and superconducting pellets 7 mounted on a bearing structure which are disposed circumferentially with respect to the axis X. The superconducting coils 6 generate the magnetic field. The pellets 7 are for example rectangular in shape. The armature 2 meanwhile comprises an arrangement of coils 5 disposed circumferentially with respect to the axis X, radially outward of the superconducting pellets 7.

The coils 5 of the armature 2 can each have a substantially rectangular shape, a longer side of which extends parallel to the axis X of the rotor. The coils 5 are assembled edge to edge along their longest side such as to define a substantially cylindrical assembly around the axis X of rotation.

The above description is then applicable mutatis mutandis to the radial flux electric machine 1. Preferably, the flux barrier 12 comprises an annular strip 13 extending circumferentially around the axis X such as to form a revolution cylinder centered on the axis X (see FIGS. 3 and 4). An axial length of the annular strip 13 (measured along the axis X) is substantially equal, to the nearest 10%, to an axial length of the superconducting pellets 7, in order to ensure an effective screening of the magnetic flux. Where applicable, the flux barrier 12 can further comprise at least one face 14, typically two opposite faces 14 extending from the annular strip 13 (FIG. 4) all the way to an area adjacent to the drive shaft.

The features of the flux barrier 12 described hereinabove in relation to the axial flux electric machine are found again mutatis mutandis in the flux barrier of a radial flux electric machine. In particular, the flux barrier 12 can be placed radially inward of the superconducting pellets 7 such as to at least partially mask the drive shaft, the cooling assembly and/or the ferrofluid seals. Moreover, the flux barrier 12 can be attached to the armature 2 or to the rotor, i.e. mounted radially inward of the coils 5 of the armature 2 or on their support structure 8.

On the other hand, in a radial flux electric machine 1, the flux barrier 12 is mounted on the bearing structure 8 (and not on the superconducting pellets 7 or the armature 2 since they extend radially with respect to the axis X).

The electric machine 1 can in particular be used in an aircraft 100.

1. A superconducting electric machine, comprising:
an inductor comprising a superconducting configured to generate a magnetic field;
superconducting pellets circumferentially distributed around an axis of the electric machine; and
a flux barrier comprising a superconducting material, the flux barrier being centered on the axis of rotation and extending radially inward of the superconducting pellets.

2. The electric machine of claim 1, wherein the flux barrier comprises an annular strip extending in a plane radial to the axis, the annular strip being coaxial with the axis.

3. The electric machine of claim 1, wherein the flux barrier comprises an annular strip extending circumferentially around the axis.

4. The electric machine of claim 3, further comprising a face extending radially toward the axis from the annular strip.

5. The electric machine of claim 4, further comprising a drive shaft configured to rotationally drive the superconducting pellets around the axis, the face of the flux barrier comprising a through orifice and the drive shaft passing through the through orifice such that the flux barrier is mounted around the drive shaft.

6. The electric machine of claim 5, further comprising an assembly for cooling at least one of the superconducting pellets and the ferrofluid seals mounted in proximity to the drive shaft through the through orifice, such that the flux barrier is mounted around at least one of the cooling assembly and the ferrofluid seals.

7. The electric machine of claim 1, further comprising an armature comprising coils circumferentially distributed around the axis, the flux barrier moving as a single part with the armature.

8. The electric machine of claim 1, wherein the flux barrier moves as a single part with the superconducting pellets.

9. The electric machine of claim 1, wherein the flux barrier is continuous over an entire periphery.

10. The electric machine of claim 1, the electric machine being an axial flux electric machine, the flux barrier extending between the superconducting pellets and the armature such as to at least partially cover the radially inner edge of all or part of the coils of the armature.

11. The electric machine of claim 10, wherein each coil has lateral edges extending radially from the radially inner edge, the flux barrier covering at the most 10% of the lateral edges.

12. An aircraft comprising an electric machine as in claim 1.

13. The electric machine as claimed in claim 3, comprising two opposite faces axially offset with respect to one another.
